(19) United States
(12) Patent Application Publication
(10) Pub. No.: US 2007/0226546 A1
(43) Pub. Date: Sep. 27, 2007

(54) Method for determining field software reliability metrics

(75) Inventors: Abhaya Asthana, Framingham, MA (US); Eric Jonathan Bauer, Freehold, NJ (US); Xuemei Zhang, Morganville, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/315,772

(22) Filed: Dec. 22, 2005

(51) Int. Cl. G06F 11/00

(52) U.S. Cl. 714/47

(57) ABSTRACT

The invention includes a method for determining a software reliability metric, including obtaining testing defect data, obtaining test case data, determining testing exposure time data using the test case data, and computing the software reliability metric using testing defect data and testing exposure time data. The defect data includes software defect records. The test case data includes test case execution time data. A testing results profile is determined using testing defect data and testing exposure time data. A software reliability model is selected according to the testing results profile. A testing defect rate and a number of residual defects are determined by using the software reliability model and the testing results profile. A testing software failure rate is determined using the testing defect rate and the number of residual defects. A field software availability metric is determined using the field software failure rate determined using the testing software failure rate.

### FIELD OF THE INVENTION

The invention relates to the field of communication networks and, more specifically, to estimating field software reliability metrics.

### BACKGROUND OF THE INVENTION

It is generally accepted that software defects are inherent in software systems (i.e., in spite of rigorous system testing, a finite number of residual defects are bound to escape into the field). Since customers often require software-based products to conform to various software reliability metrics, numerous software reliability estimation models have been developed for predicting software reliability prior to deployment of the software to the field. For example, the defect propagation model (DPM) uses historical defect data, as well as product size information, to estimate the injected and removed defects for each major development phase. Disadvantageously, however, DPM requires apriori knowledge of the processes used to develop the software in order to estimate historical defect data.

Furthermore, many other software reliability models developed for estimating software reliability metrics often cannot be used due to a lack of data required for generating software reliability estimates. For example, one such model utilizes calendar testing time for estimating software reliability. Disadvantageously, however, calendar testing time does not provide an accurate measure of software testing effort. For example, a decreasing trend of software defect reporting per calendar week may not necessarily mean that the software quality is improving (e.g., it could be a result of reduced test efforts, e.g., during a holiday week in which system testers take vacations and may be comparatively less focused than during non-holiday weeks).

### SUMMARY OF THE INVENTION

Various deficiencies in the prior art are addressed through the invention of a method for determining a software reliability metric. The method includes obtaining testing defect data, obtaining test case data, determining testing exposure time data using the test case data, and computing the software reliability metric using testing defect data and testing exposure time data. The defect data includes software defect records. The test case data includes test case execution time data. A testing results profile is determined using testing defect data and testing exposure time data. A software reliability model is selected according to the testing results profile. A testing defect rate and a number of residual defects are determined by using the software reliability model and the testing results profile. A testing software failure rate is determined using the testing defect rate and the number of residual defects. In one embodiment, the testing software failure rate may be calibrated for predicting field software failure rate using a calibration factor. In one such embodiment, the calibration factor may be estimated by correlating testing failure rates and field failure rates of previous software/product releases. A field software availability metric is determined using the field software failure rate determined using the testing software failure rate.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a testing environment including a plurality of testing systems for executing test cases in an associated plurality of test beds;

FIG. 2 depicts a flow diagram of a method of one embodiment of the invention;

FIG. 3A depicts a testing results profile conforming to a concave software reliability model;

FIG. 3B depicts a testing results profile conforming to a delayed S-shape software reliability model;

FIG. 4 depicts a flow diagram of a method of one embodiment of the invention; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

In general, software reliability is improved by implementing robust, fault-tolerant architectures and designs, removing residual software defects, and efficiently detecting, isolating, and recovering from failures. A two-prong approach is often employed for providing software quality assurance: (1) a software quality assurance based defect tracking system is used to manage software development process and product quality and (2) a software reliability model (e.g., Software Reliability Growth Model/Modeling (SRGM)) is used for predicting field software reliability. Since it is generally accepted that software faults are inherent in software systems (i.e., in spite of rigorous system testing, a finite number of residual defects are bound to escape into the field). By providing a realistic estimate of software reliability prior to product deployment, the present invention provides guidance for improved decision-making by balancing reliability, time-to-market, development, and like parameters, as well as various combinations thereof.

Since the number of defects detected and removed during system test is not an adequate measure of the reliability of system software in the field, the present invention utilizes a combination of defect data and testing exposure time data for determining a testing software failure rate, where the testing exposure time is determining using test case data (e.g., the total number of executed test cases, average test case execution times, the nature and scope of test cases executed, the rate at which defects are discovered during the test cycle, and like information). In accordance with the present invention, the testing software failure rate may be used for estimating an associated field software failure rate, which may be used for estimating various field software reliability metrics.

The present invention utilizes a software reliability model for determining the testing software failure rate. As described herein, any software reliability model may be adapted in accordance with the present invention for determining testing software failure metrics and estimating associated field software failure metrics; however, the present invention is primarily described herein within the context of SRGM adapted in accordance with the present invention. In general, SRGM adapted in accordance with the present invention enables estimation of the rate of encountering software defects and calibrates the software defect rate to a likely outage-inducing software failure rate for field operation. Since SRGM requires no a priori knowledge of processes used for software development, SRGM provides accurate software reliability metrics estimates for open source, third party, and other “not-developed-here” software elements.

An SRGM in accordance with the present invention normalizes testing defect data (e.g., modification request records) using testing exposure time determined according to test case data (as opposed to existing software reliability prediction models which typically use calendar testing time for predicting software reliability). In one embodiment, an SRGM in accordance with the present invention focuses on stability-impacting software defect data for improving outage-inducing software failure rate predictions. In an SRGM adapted in accordance with the present invention, corrections for variations in test effort (e.g., scheduling constraints, resource constraints, staff diversions, holidays, sickness, and the like) may be made.

The present invention provides significant improvements in determining testing software failure rate and, therefore, provides a significant improvement in predicting field software failure rate, as well as associated field software reliability metrics (irrespective of the software reliability model adapted in accordance with the present invention). Although the present invention is primarily discussed within the context of a software testing environment including a plurality of testing systems for executing software test cases using a plurality of test beds, and a testing results analysis system using a specific software reliability model adapted in accordance with the present invention; the present invention can be readily applied to various other testing environments using various other analysis systems and associated software reliability models.

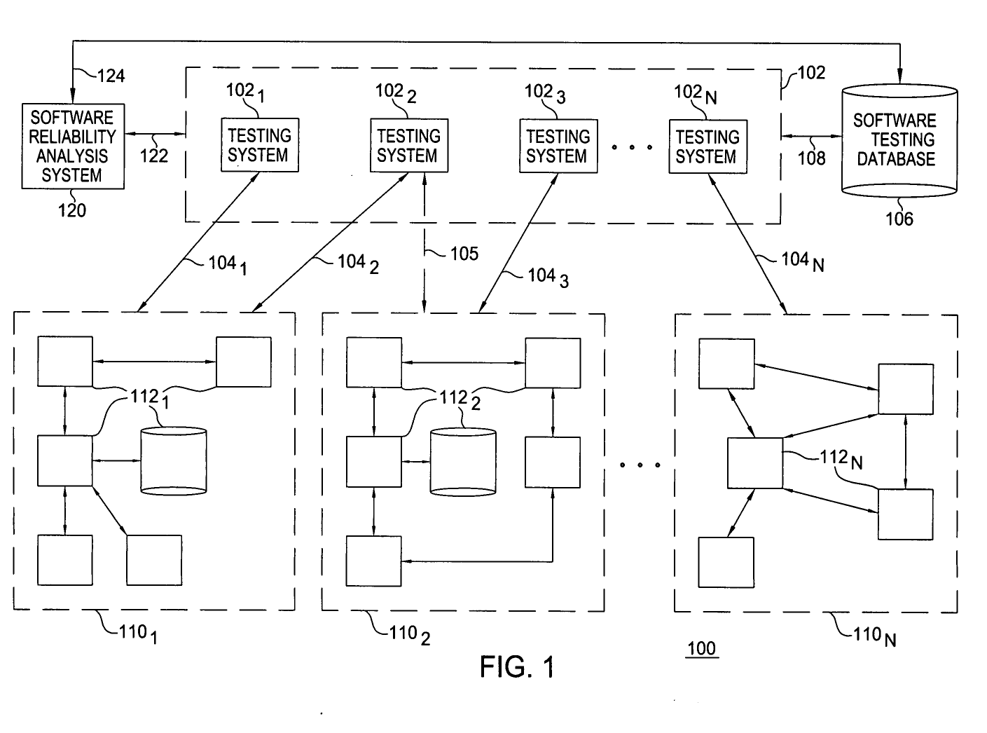

FIG. 1 depicts a high-level block diagram of a testing environment. In particular, testing environment 100 of FIG. 1 includes a plurality of testing systems 102₁-102_{N} (collectively, testing systems 102), a software testing database 106, a plurality of test beds 110₁-110_{N} (collectively, test beds 110), and a software reliability analysis system 120. The testing systems 102₁-102_{N} communicate with test beds 110₁-110_{N} using a respective plurality of communication links 104₁-104_{N} (collectively, communication links 104). Specifically, testing systems 102₁ and 102₂ communicate with test bed 110₁, testing system 102₃ communicates with test bed 110₂, and testing system 102_{N} communicates with test bed 110_{N}. As depicted in FIG. 1, testing system 102₂ optionally communicates with test bed 110₂ using a communication link 105 (i.e., a testing system 102 may communicate with multiple test beds). The testing systems 102 communicate with testing database 106 using a respective plurality of communication links, which, for purposes of clarity are depicted as a communication link 108.

As depicted in FIG. 1, test bed 110₁ includes a plurality of network elements 112₁ (collectively, network elements 112₁) and test bed 110₂ includes a plurality of network elements 112₂ (collectively, network elements 112₂). For purposes of clarity, network elements associated with test bed 110_{N} are not depicted. The network elements 112₁ and 112₂ are collectively denoted as network elements 112. The network elements 112 may include switches, multiplexers, controllers, databases, management systems, and various other network elements utilizing software for performing various functions. In one embodiment, as depicted in FIG. 1, test beds 110 may be configured differently (e.g., using different configurations of network elements 112) for executing test cases using different network configurations, for executing different test cases requiring different network configurations, and the like.

As depicted in FIG. 1, testing systems 102 include systems operable for performing software testing. In one embodiment, testing systems 102 include systems adapted for performing software testing functions (e.g., user terminals including input/output components, processing components, display components, and like components for enabling a software tester to perform various software testing functions). For example, testing systems 102 adapted for performing software testing may be used by software testers for creating test cases, executing test cases, collecting testing results, processing testing results, generating testing defect records (e.g., modification requests) based on testing results, and performing like software testing functions. As depicted in FIG. 1, testing systems 102 interact with software testing database 106 for performing at least a portion of the software testing functions.

As depicted in FIG. 1, in one embodiment, at least a portion of testing systems 102 include systems adapted for supplementing software testing functions. For example, testing systems 102 adapted for supplementing software testing functions may be configured for generating network configuration commands, generating network traffic, generating network failure conditions, and performing like functions for supplementing software testing functions. In one such embodiment, the testing systems adapted for supplementing software testing functions may be controlled by at least a portion of the testing systems 102 adapted for performing software testing functions for supplementing software testing functions initiated by software testers using other testing systems (illustratively, other testing systems 102).

As depicted in FIG. 1, software reliability analysis system 120 is a system adapted for determining at least one software reliability metric. The software reliability analysis system 120 performs at least a portion of the methodologies of the present invention. For example, software reliability analysis system 120 may obtain defect data (e.g., modification request data), obtain testing data (e.g., test case data, test case execution time data, and the like), determine testing exposure time data using the testing data, determine a testing software reliability metric using the defect data and testing exposure time data, and predict a field software reliability metric using the testing software reliability metric. As depicted in FIG. 1, software reliability system 120 communicates with testing systems 102 and software testing database 106 using respective pluralities of communication links (which, for purposes of clarity, are depicted as communication links 122 and 124) for performing at least a portion of the methodologies of the present invention.

Although depicted as comprising specific numbers of testing systems, testing databases, and test beds, the methodologies of the present invention may be performed using fewer or more testing systems, testing databases, and test beds. Furthermore, although each test bed is depicted using specific network element configurations, the methodologies of the present invention may be applied to various other network element configurations. Although the testing environment 100 of FIG. 1 may be used for determining various software reliability metrics in accordance with various software reliability models, the present invention is primarily described herein with respect to the Software Reliability Growth Modeling (SRGM).

In general, an outage-inducing software failure is an event that (1) causes major or total loss of system functionality and (2) requires a process, application, processor, or system restart/failover to recover. The root cause of outage-inducing software failures is severe residual defects. The relationship of severe residual defects to outage-inducing software failure rate is nonlinear because (1) only a small portion of residual defects cause outages or stability problems, (2) frequency of execution of lines of code is non-uniform, and (3) residual defects only cause failures upon execution of the corresponding program code segment. An SRGM in accordance with the present invention accounts for this nonlinear relationship between residual defects and software failure rate.

An SRGM in accordance with the present invention may utilize various technical assumptions for simplifying determination of a testing software failure rate, as well as field software failure rate and corresponding field software reliability metrics. The technical assumptions may include one or more of the following assumptions: (1) the outage inducing software failure rate is related to frequency of severe residual defects; (2) there is a finite number of severe defects in any software program and, as defects are found and removed, encountering additional severe defects is less likely; and (3) the frequency of system testers discovering new severe defects is assumed to be directly related to likely outage-inducing software failure rate, and like assumptions, as well as various combinations thereof.

An SRGM in accordance with the present invention may utilize various operational assumptions for simplifying determination of a testing software failure rate, as well as field software failure rate and corresponding field software reliability metrics. The technical assumptions may include one or more of the following assumptions: (1) system test cases mimic operational profiles of the associated customers; (2) system testers recognize the difference between a severe outage-inducing software failure and a non-severe software event; (3) a product unit fixes the majority of severe defects discovered prior to general availability; and (4) system test cases are executed in a random, uniform manner (e.g., difficult test cases, rather than being clustered, are distributed across the entire testing interval). Although specific technical and operation assumptions are listed, various other assumptions may be made.

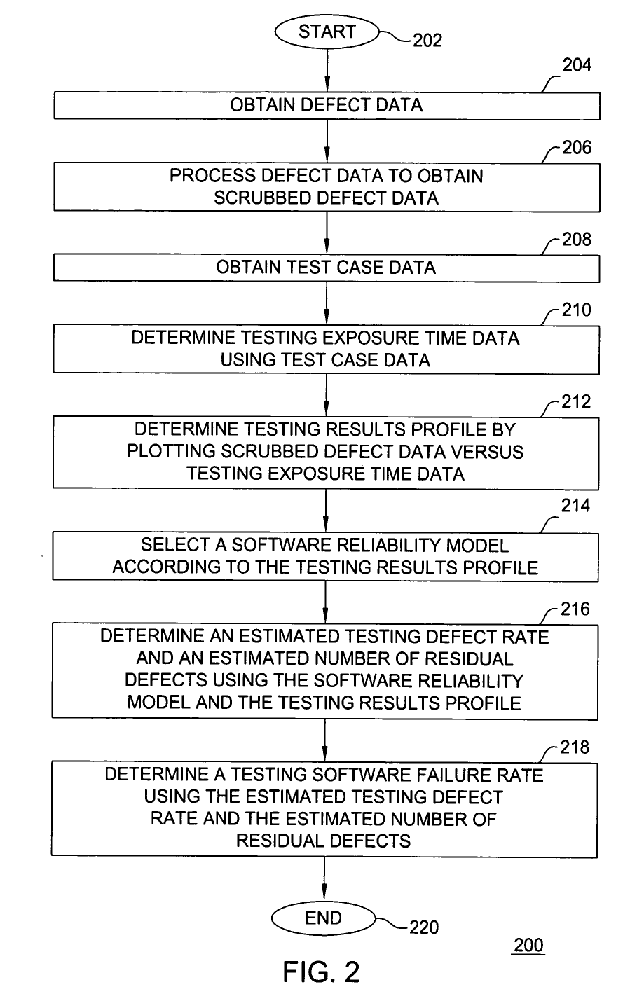

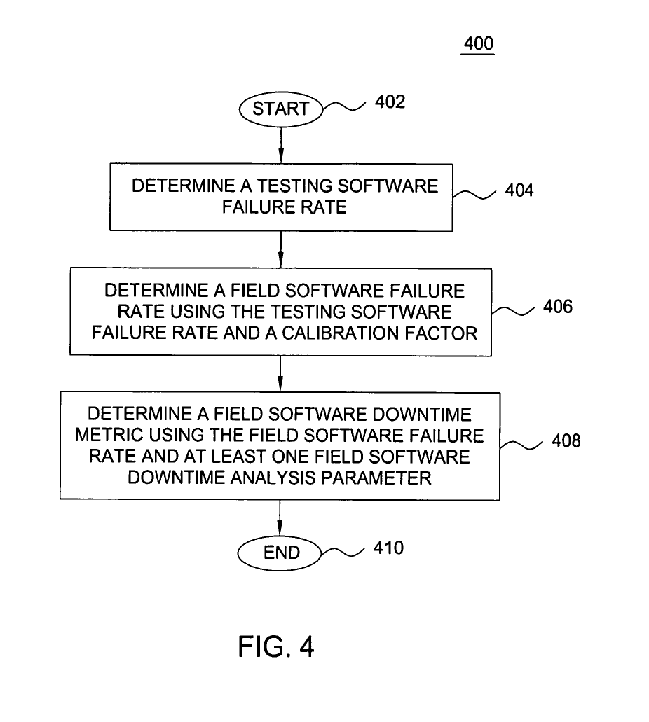

FIG. 2 depicts a flow diagram of a method according to one embodiment of the invention. Specifically, method 200 of FIG. 2 comprises a method for determining at least one testing software reliability metric. In one embodiment, the testing software reliability metric determined as depicted and described with respect to FIG. 2 may be used for determining at least one field software reliability metric, as depicted and described herein with respect to FIG. 4. Although depicted as being performed serially, those skilled in the art will appreciate that at least a portion of the steps of method 200 may be performed contemporaneously, or in a different order than presented in FIG. 2. The method 200 begins at step 202 and proceeds to step 204.

At step 204, defect data is obtained. In one embodiment, defect data comprises software testing defect data (e.g., software defect records such as modification request (MR) records). In one embodiment, defect data includes historical defect data. For example, defect data may include known residual defects from previous releases, assuming the residual defects are not fixed during field operations using software patches. For example, defect data may include software defect trend data from a previous release of the system currently being tested, from a previous release of a system similar to the system currently being tested, and the like. In one embodiment, defect data is obtained locally (e.g., retrieved from a local database (not depicted) of software reliability analysis system 120). In another embodiment, defect data is obtained remotely from another system (illustratively, from software testing database 106).

At step 206, the defect data is processed to obtain scrubbed defect data. In one embodiment, processing defect data to obtain scrubbed defect data includes filtering the defect data for avoiding inaccuracies in testing exposure time determination processing. In one embodiment, the full set of available defect data is filtered. In order to avoid inaccuracies of testing exposure time determinations, in one embodiment, all available defect data is filtered such that defect data produced by testing covered by test exposure estimates is retained for use in further testing exposure time determinations. In performing such filtering, a distinction may be made between the source of the defect data (i.e., in addition to being generated by system testers, MRs may be generated by product managers, system engineers, developers, technical support engineers, customers, and people performing various other job functions).

In one embodiment, defect data filtering includes filtering modification request data. In one embodiment, MR data filtering is performed in a manner for retaining a portion of the full set of available modification request data. In one such embodiment, MR data filtering is performed in a manner for retaining MRs generated from system feature testing, MRs generated from stability testing, and MRs generated from soak testing. In this embodiment, the MRs generated from system feature testing, stability testing, and soak testing are retained because such MRs typically yield high-quality data with easy-to-access test exposure data.

In one embodiment, MR data filtering is performed in a manner for removing a portion of the full set of available modification request data. In one such embodiment, MR data filtering is performed in a manner for removing MRs generated from developer coding and associated unit testing activities, MRs generated from unit integration testing and system integration testing, MRs generated from systems engineering document changes, and MRs generated from field problems. In this embodiment, MRs generated from developer coding and associated unit testing, MRs generated from unit and system integration testing, MRs generated from systems engineering document changes, and MRs generated from field problems are removed due to the difficulty associated with estimating the testing effort required for exposing defects associated with the enumerated activities.

In one embodiment, processing defect data to obtain scrubbed defect data includes processing the defect data for identifying software defects likely to cause outages in the field. In one embodiment, MR data is processed for identifying MR records likely to cause service outages. In one such embodiment, all available MR data is processed for identifying MRs indicating software faults likely to cause service outages. In another such embodiment, a subset of all available modification request data (i.e., a filtered set of MR data) is processed for identifying MRs indicating software faults likely to cause service outages. The processing of MR data for identifying MRs indicating software faults likely to cause service outages may be performed using one of a plurality of processing options.

In one embodiment, MR data is filtered for identifying service-impacting software defects. In one embodiment, each MR record may include a service-impacting attribute for use in filtering the MR data for identifying service-impacting software defects. In one embodiment, the service-impacting attribute may be implemented as a flag associated with each MR record. In one such embodiment, the service-impacting attribute may be used for identifying an MR associated with a software problem that is likely to disrupt service (whether or not the event is automatically detected and recovered by the system). In one embodiment, the service-impacting attribute is product-specific.

In one embodiment, MR data is filtered for identifying service-impacting software defects. In one embodiment, each MR record may include a severity attribute for use in filtering the MR data for identifying service-impacting software defects. In one embodiment, the MR severity attribute is implemented using four severity categories (e.g., severity-one (typically the most important defects requiring immediate attention) through severity-four (typically the least important defects unlikely to ever result in a software failure and, furthermore, often even transparent to customers). In one embodiment, the full set of MR data is filtered for retaining all severity-one and severity-two MRs. In this embodiment, all remaining severity-one and severity-two MRs are used for generating the testing results profile in accordance with the present invention.

In another such embodiment, severity-one and severity-two MRs are further processed for identifying service-impacting defects (i.e., MRs other than severity-one and severity-two MRs, e.g., severity-three and severity-four MRs are filtered such that they are not processed for identifying service-impacting defects). In one such embodiment, the remaining severity-one and severity-two MRs are filtered to remove duplicate MRs, killed MRs, and RFE MRs. In this embodiment, the remaining severity-one and severity-two MRs are processed in order to identify service-impacting MRs. In one further embodiment, each identified service-impacting MR is processed in order to determine the source subsystem associated with that service-impacting MR.

At step 208, test case data is obtained. In one embodiment, test case data includes test case execution data. In one such embodiment, test case data includes the number of tests cases executed during a particular time period (e.g., a randomly selected time period, a periodic time period, and the like), an average test case execution time (i.e., the average time required for executing a test case, excluding test case setup time, modification request reporting time, and the like), and the like. The test case data may be obtained for any of a plurality of testing scopes (e.g., per test case, for a group of test cases, per test bed, for the entire testing environment, and various other scopes). In one embodiment, test case data is obtained locally (e.g., retrieved from a local database (not depicted) of software reliability analysis system 120). In another embodiment, test case data is obtained remotely from another system (illustratively, from software testing database 106).

In one embodiment, test case data is processed for filtering at least a portion of the test case data. In one such embodiment, test completion rate is determined using the number of planned test cases, the number of executed test cases, and the number of other test cases (e.g., the number of deferred test cases, the number of dropped test cases, and the like). It should be noted that if a substantial number of the planned test cases become other test cases (e.g., dropped test cases, deferred test cases, and the like), the software testing results profile (e.g., SRGM operational profile selected according to the testing results profile) cannot be assumed similar to the software field profile (i.e., the operational profile of the software operating in the field).

At step 210, testing exposure time data for use in generating a testing results profile is determined using the test case data. In accordance with the present invention, since lab testing typically reflects a highly-accelerated version of a typical operational profile of a typical customer, testing exposure data is used for determining testing software failure rate for use in generating field software reliability predictions. Furthermore, since testing exposure time is not available, and since different forms of test case data (e.g., test case execution time data) accurately reflects testing efforts, test case data is used to approximate testing exposure time in accordance with the present invention.

In one embodiment, testing exposure time is determined by processing the available test case data. In one such embodiment, the test case data is processed for determining test execution time data. In one such embodiment, test execution time is collected during execution of each test case. In one such embodiment, test execution time may be collected using any of a plurality of test execution time collection methods. In another such embodiment, test execution time is estimated by processing each test case according at least one test case parameter. For example, test case execution time may be estimated according to the difficulty of each test case (e.g., the number of steps required to execute the test case, the number of different systems, modules, and the like that must be accessed in order to execute each test case, and the like).

In another embodiment, test execution time is determined by processing test case data at a scope other than processing data associated with each individual test case. In one such embodiment, test execution time is determined by processing at least one testing time log generated during system test case execution. In another such embodiment, test exposure time comprises test-bed based test exposure time. In one such embodiment, test-bed based test exposure time is collected periodically (e.g., daily, weekly, and the like). In another such embodiment, the test-bed based exposure time comprises a test execution time for each test-bed in a system test interval. In one such embodiment, the system test interval time excludes test setup time, MR reporting time, and like time intervals associated with system test execution time.

At step 212, a testing results profile is determined. In one embodiment, the testing results profile is determined by processing the defect data and testing exposure time data for correlating the defect data to the testing exposure time data. In one embodiment, the correlated defect data and testing exposure time data is plotted (e.g., defect data on the ordinate axis and testing exposure time data on the abscissa) to form a graphical representation of the testing results profile. In one such embodiment, correlation of the defect data and testing exposure time data comprises determining the cumulative number of software defects identified at each time in the cumulative testing exposure time. In this embodiment, cumulative defect data is plotted against cumulative testing exposure time data to form a graphical representation of the testing results profile. The testing exposure time data may be represented using any of a plurality of test execution time measurement units (irrespective of the means by which the test execution time data is determined).

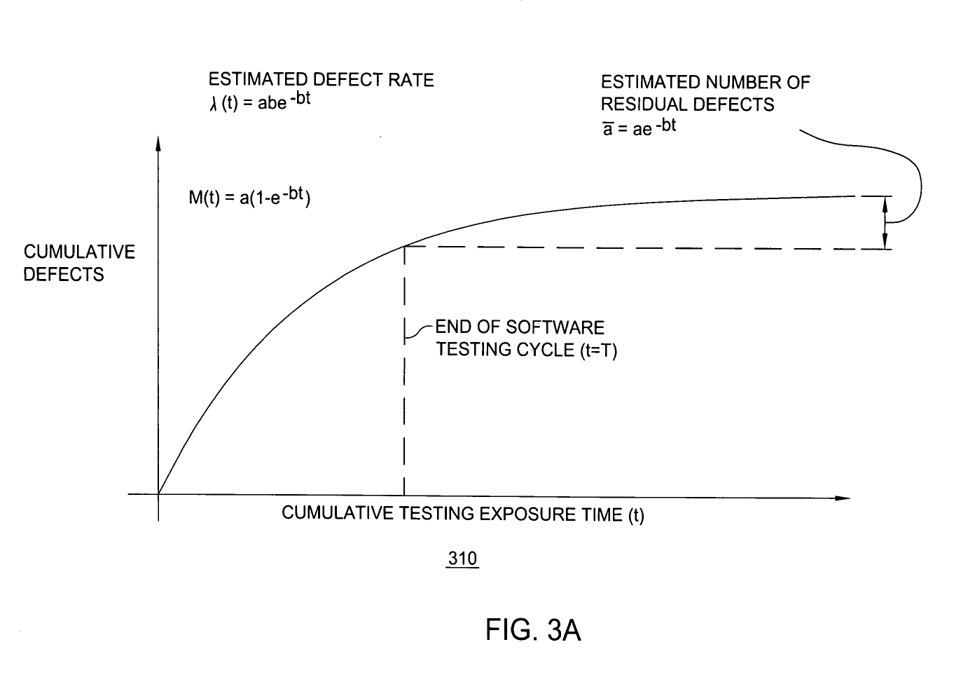

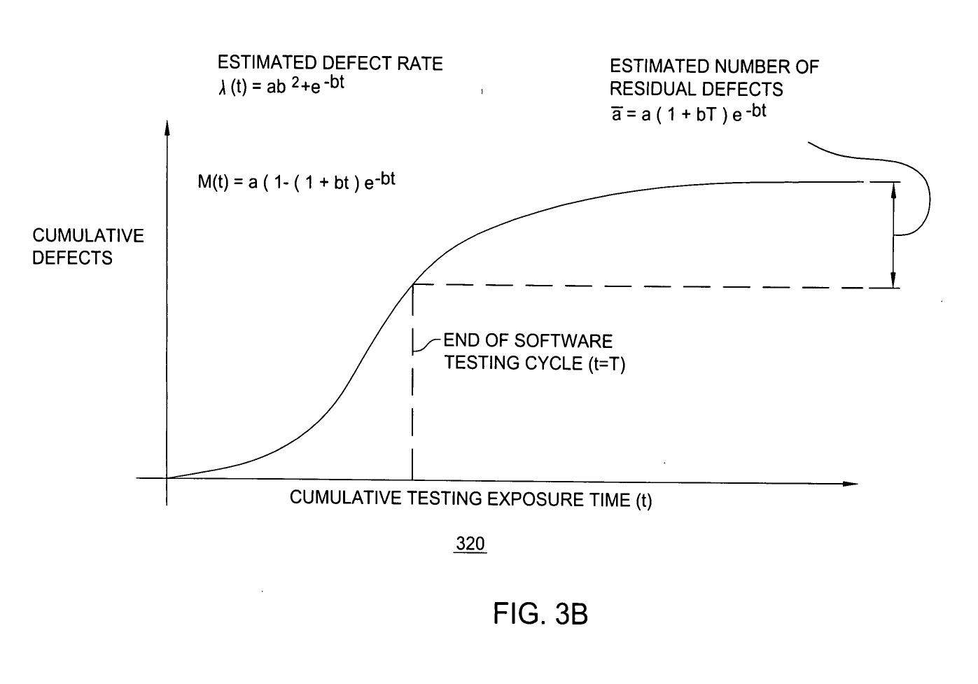

At step 214, a software reliability model is selected according to the testing results profile. In one embodiment, selection of a software reliability model is performed using the correlated defect data and testing exposure time data of the testing results profile (i.e., a non-graphical representation of the testing results profile). In another embodiment, selection of a software reliability model is performed using the graphical representation of the testing results profile. In one embodiment, the selected software reliability model comprises one of the Software Reliability Growth Model variations (as depicted and described herein with respect to FIG. 3A and FIG. 3B). Although primarily described herein with respect to selection of one of the variations of the Software Reliability Growth Model, various other software reliability models may be selected using the testing results profile.

At step 216, at least one testing software reliability metric is determined. In one embodiment, a testing defect rate and a number of residual defects are determined. In one embodiment, the testing defect rate and number of residual defects are determined by applying the software reliability model to the testing results profile. In one embodiment, the testing defect rate is a per-defect failure rate. The determination of the testing defect rate and a number of residual defects using selected software reliability model and the testing results profile is depicted and described herein with respect to FIG. 3A and FIG. 3B. At step 218, a testing software failure rate is determined using the testing defect rate and the number of residual defects. At step 220, the method ends.

As described herein, the testing results profile is processed for selecting the model used for determining a testing software failure rate which is used for estimating a field software failure rate. In one embodiment, the testing results profile includes the obtained defect data and testing exposure data. In one embodiment, the obtained defect data includes the cumulative identified testing defects (i.e., the cumulative number of defects identified at each time of the testing exposure time). In one embodiment, the testing exposure data includes cumulative testing time (i.e., the cumulative amount of testing time required to execute the test cases from which the defects are identified). In one embodiment, the testing results profile is represented graphically (e.g., with cumulative identified failures represented on the ordinate axis and cumulative testing time represented on the abscissa axis).

In one embodiment, the testing results profile is compared to standard results profiles associated with respective software reliability models available for selection. The software reliability model associated with the standard results profile most closely matching the testing results profile is selected. As described herein, in one embodiment, the selected software reliability model comprises a Software Reliability Growth Model (i.e., one of the Software Reliability Growth Model versions). In one example, depicted and described herein with respect to FIG. 3A, a testing results profile is an SRGM concave profile, thereby resulting in selection of a concave model. In another example, depicted and described herein with respect to FIG. 3B, a testing results profile is an SRGM delayed S-shape profile, thereby resulting in selection of a delayed S-shape model.

FIG. 3A depicts a concave testing results profile processed for identifying a concave software reliability model adapted for determining a testing defect rate estimate and a residual defects estimate. Specifically, concave testing results profile 310 of FIG. 3A is depicted graphically using cumulative software defects (ordinate axis) versus cumulative testing exposure time (abscissa axis). As depicted in FIG. 3A, in the direction of increasing cumulative testing exposure time, concave testing results profile 310 of FIG. 3A has a continuously decreasing slope (i.e., the rate at which the cumulative number of failures increases continuously decreases as the cumulative testing exposure time increases). By comparing concave testing results profile 310 with a database of software reliability models (e.g., each of the SRGM versions), the concave model is identified as the most closely conforming model.

In accordance with the concave model selected according to the concave testing results profile 310 depicted in FIG. 3A, the expected number of failures over time (denoted as M(t)) may be represented as M(t)=a(1−e^{-bt}), where a is the initial number of faults in the test environment, b is the average per-fault failure rate, t is the cumulative testing exposure time (across all test beds in the testing environment), and T is the current value of t. Using the concave model selected according to the concave testing results profile 310 depicted in FIG. 3A, the estimated defect rate (denoted as λ(t)) may be represented as λ(t)=b[ae^{-bt}]. Using the concave model selected according to the concave testing results profile 310 depicted in FIG. 3A, the estimated number of residual defects (denoted as a̅) may be represented as a̅=ae^{-bt}. As described herein, the estimate defect rate and estimated number of residual defects may be used for determining at least one other software reliability metric, as depicted and described herein with respect to FIG. 4.

FIG. 3B depicts a delayed S-shape testing results profile processed for identifying a delayed S-shape software reliability model adapted for determining a testing defect rate estimate and a residual defects estimate. Specifically, delayed S-shape testing results profile 320 of FIG. 3B is depicted graphically using cumulative software defects (ordinate axis) versus cumulative testing exposure time (abscissa axis). As depicted in FIG. 3B, in the direction of increasing cumulative testing exposure time, delayed S-shape testing results profile 320 of FIG. 3B has a continuously increasing slope (i.e., the rate at which the cumulative number of failures increases continuously increases as the cumulative testing exposure time increases) changing to a continuously decreasing slope (i.e., the rate at which the cumulative number of failures increases continuously decreases as the cumulative testing exposure time increases) in the direction of increasing cumulative testing exposure time. By comparing delayed S-shape testing results profile 320 with a database of software reliability models (e.g., each of the SRGM versions), the delayed S-shape model is identified as the most closely conforming model.

In accordance with the delayed S-shape model selected according to the delayed S-shape testing results profile 320 depicted in FIG. 3B, the expected number of failures over time (denoted as M(t)) may be represented as M(t)=a(1−(1+bt)e^{-bt}), where a is the initial number of faults in the test environment, b is the average per-fault failure rate, t is the cumulative testing exposure time (across all test beds in the testing environment), and T is the current value of t. Using the delayed S-shape model selected according to the delayed S-shape testing results profile 320 depicted in FIG. 3B, the estimated defect rate (denoted as λ(t)) may be represented as λ(t)=ab²(t^{-bt}). Using the delayed S-shape model selected according to the delayed S-shape testing results profile 320 depicted in FIG. 3B, the estimated number of residual defects (denoted as a̅) may be represented as a̅=a(1+bT)e^{-bT}. As described herein, the estimated defect rate and estimated number of residual defects may be used for determining at least one other software reliability metric, as depicted and described with respect to FIG. 4.

As depicted in FIG. 3A, the concave testing results profile indicates that the rate at which the cumulative number of defects identified during testing continuously decreased as the cumulative testing exposure time increases. Similarly, as depicted in FIG. 3B, the delayed S-shaped testing results profile indicates that, after the portion of the curve in which the cumulative number of defects identified during testing increases, the cumulative number of defects identified during testing then continuously decreases as the cumulative testing exposure time increases. By extrapolating the testing results profile curves, the total cumulative number of defects in the software (i.e., the number of defects introduced into the software during the various software development phases, e.g., requirements phase, architecture design phase, development phase, and testing phase) may be estimated.

As depicted in FIG. 3A and FIG. 3B, since the cumulative number of defects identified at the completion of testing (i.e., at the time the software is deployed to the field) is known and the total cumulative number of defects in the software may be estimated, a difference between total cumulative number of defects in the software and the cumulative number of defects identified at the completion of testing yields an estimate of the number of residual defects remaining in the software upon deployment of the software to the field.

Although depicted and described herein with respect to a concave testing results profile and associated concave software reliability model (FIG. 3A) and a delayed S-shape testing results profile and associated delayed S-shape software reliability model (FIG. 3B), those skilled in the art will appreciate that various other testing results profiles may be identified, thereby resulting in selection of various other Software Reliability Growth Models. Furthermore, although primarily depicted and described herein with respect to different variations of the Software Reliability Growth Model, the present invention may be implemented using various other software reliability models.

FIG. 4 depicts a flow diagram of a method according to one embodiment of the invention. Specifically, method 400 of FIG. 4 comprises a method for determining a field software reliability metric. In one embodiment, the testing software reliability metric determined as depicted and described herein with respect to FIG. 2 may be used for determining the field software reliability metric. Although depicted as being performed serially, those skilled in the art will appreciate that at least a portion of the steps of method 400 may be performed contemporaneously, or in a different order than presented in FIG. 4. The method 400 begins at step 402 and proceeds to step 404.

At step 404, a testing software reliability metric is determined. In one embodiment, the testing software reliability metric comprises a testing software failure rate. In one such embodiment, the testing software failure rate is determined according to method 200 depicted and described herein with respect to FIG. 2. At step 406, a field software failure rate is determined using the testing software failure rate and a calibration factor. At step 408, a field software downtime metric is determined using the field software failure rate and at least one field software downtime analysis parameter. At step 410, the method ends.

In one embodiment, the field software downtime analysis parameter is a coverage factor. In general, software-induced outage rate is typically lower than software failure rate for systems employing redundancy since failure detection, isolation, and recovery mechanisms permit a portion of failures to be automatically recovered (e.g., using a system switchover to redundant elements) in a relatively short period of time (e.g., within thirty seconds). In one embodiment, software failure rate is computed as software outage rate divided by software coverage factor. In one such embodiment, software coverage factor may be estimated from an analysis of fault insertion test results.

In one embodiment, the field software downtime analysis parameter is a calibration factor. In one embodiment, a testing software failure rate (i.e., a software failure rate in a lab environment) is correlated with a field software failure rate (i.e., a software failure rate in a field environment) according to the calibration factor. In one embodiment, a calibration factor is consistent across releases within a product, across a product family, and the like. In one embodiment, a calibration factor is estimated using historical testing and field software failure rate data. For example, in one embodiment, the calibration factor may be estimated by correlating testing failure rates and field failure rates of previous software/product releases.

In one embodiment, additional field software reliability data may be used for adjusting field software reliability estimates. In one embodiment, field software reliability estimates may be adjusted according to directly recorded outage data, outage data compared to an installed base of systems, and the like. In another embodiment, field software reliability estimates may be adjusted according to estimates of the appropriate number of covered in-service systems (e.g., for one customer, for a plurality of customers, worldwide, and on various other scopes). In another embodiment, field software reliability estimates may be adjusted according to a comparison of outage rate calculations to in-service time calculations.

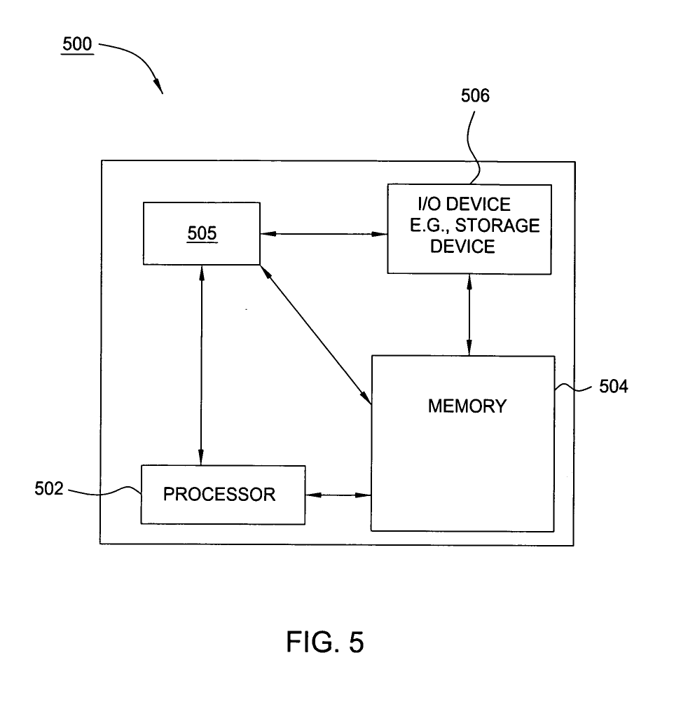

FIG. 5 depicts a high-level block diagram of a general purpose computer suitable for use in performing the functions described herein. As depicted in FIG. 5, system 500 comprises a processor element 502 (e.g., a CPU), a memory 504, e.g., random access memory (RAM) and/or read only memory (ROM), a software reliability analysis module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present software reliability analysis module or process 505 can be loaded into memory 504 and executed by processor 502 to implement the functions as discussed above. As such, software reliability analysis process 505 (including associated data structures) of the present invention can be stored on a computer readable medium or carrier, e.g., RAM memory, magnetic or optical drive or diskette and the like.

Although primarily described herein with respect to specific software reliability metrics, attributes, and the like, various other software reliability metrics and attributes may be determined, processed, and utilized in accordance with the present invention, including the size of new code as compared to the size of base code, the complexity/maturity of new code and third party code, testing coverage, testing completion rate, severity consistency during the test interval (as well as between the test and field operations), post-GA MR severities and uniqueness, total testing time, the number of negative/adversarial tests, and like metrics, attributes, and the like, as well as various combinations thereof.

Although various embodiments which incorporate the teachings of the present invention have been shown and described in detail herein, those skilled in the art can readily devise many other varied embodiments that still incorporate these teachings.

What is claimed is:

1. A method for determining a software reliability metric, comprising:
obtaining testing defect data;
obtaining test case data associated with the testing defect data;
determining testing exposure time data using the test case data; and
computing the software reliability metric using the testing defect data and the testing exposure time data.

2. The method of claim 1, wherein computing the software reliability metric comprises:
generating a testing results profile using the testing defect data and the testing exposure time data;
selecting a software reliability model according to the testing results profile; and
computing the software reliability metric using the software reliability model and the testing results profile.

3. The method of claim 2, wherein generating the testing results profile comprises:
processing the testing defect data for producing cumulative testing defect data;
processing the testing exposure time data for producing cumulative testing exposure time data; and
associating the cumulative testing defect data with the cumulative testing exposure time data to form thereby the testing results profile.

4. The method of claim 3, wherein associating the cumulative testing defect data with the cumulative testing exposure time data comprises:
plotting the cumulative testing defect data against the cumulative testing exposure time data to form thereby a graphical representation of the testing results profile.

5. The method of claim 2, wherein computing the software reliability metric using the software reliability model and the testing results profile comprises:
determining a testing defect rate using the software reliability model and the testing results profile;
determining a number of residual defects using the software reliability model and the testing results profile; and
computing the software reliability metric using the testing defect rate and the number of residual defects.

6. The method of claim 5, wherein the testing defect rate is determined using a slope of a graphical representation of the testing results profile, the graphical representation of the testing results profile formed by:
processing the testing defect data for producing cumulative testing defect data;
processing the testing exposure time data for producing cumulative testing exposure time data; and
plotting the cumulative testing defect data against the cumulative testing exposure time data to form thereby a graphical representation of the testing results profile.

7. The method of claim 5, wherein the software reliability metric comprises a testing software failure rate.

8. The method of claim 7, further comprising:
determining a field software failure rate using the testing software failure rate and a calibration factor, wherein the calibration factor is determined using historical failure data.

9. The method of claim 8, further comprising:
determining a field software availability metric using the field software failure rate and at least one availability parameter.

10. The method of claim 1, wherein the testing defect data comprises a plurality of modification request records, wherein the test case data comprises at least one of a number of completed test cases, an average test case completion time, a total test case completion time, or at least one test case attribute.

11. A computer readable medium storing a software program, that, when executed by a computer, causes the computer to perform a method comprising:
obtaining testing defect data;
obtaining test case data associated with the testing defect data;
determining testing exposure time data using the test case data; and
computing the software reliability metric using the testing defect data and the testing exposure time data.

12. The computer readable medium of claim 11, wherein computing the software reliability metric comprises:
generating a testing results profile using the testing defect data and the testing exposure time data;
selecting a software reliability model according to the testing results profile; and
computing the software reliability metric using the software reliability model and the testing results profile.

13. The computer readable medium of claim 12, wherein generating the testing results profile comprises:
processing the testing defect data for producing cumulative testing defect data;
processing the testing exposure time data for producing cumulative testing exposure time data; and
associating the cumulative testing defect data with the cumulative testing exposure time data to form thereby the testing results profile.

14. The computer readable medium of claim 13, wherein associating the cumulative testing defect data with the cumulative testing exposure time data comprises:
plotting the cumulative testing defect data against the cumulative testing exposure time data to form thereby a graphical representation of the testing results profile.

15. The computer readable medium of claim 12, wherein computing the software reliability metric using the software reliability model and the testing results profile comprises:
determining a testing defect rate using the software reliability model and the testing results profile;
determining a number of residual defects using the software reliability model and the testing results profile; and
computing the software reliability metric using the testing defect rate and the number of residual defects.

16. The computer readable medium of claim 15, wherein the testing defect rate is determined using a slope of a graphical representation of the testing results profile, the graphical representation of the testing results profile formed by:
processing the testing defect data for producing cumulative testing defect data;
processing the testing exposure time data for producing cumulative testing exposure time data; and
plotting the cumulative testing defect data against the cumulative testing exposure time data to form thereby a graphical representation of the testing results profile.

17. The computer readable medium of claim 15, wherein the software reliability metric comprises a testing software failure rate.

18. The computer readable medium of claim 17, further comprising:
determining a field software failure rate using the testing software failure rate and a calibration factor, wherein the calibration factor is determined using historical failure data.

19. The computer readable medium of claim 18, further comprising:
determining a field software availability metric using the field software failure rate and at least one availability parameter.

20. A method for determining a software reliability metric, comprising:
obtaining defect data comprising a plurality of software defect records;
filtering the software defect records for removing at least a portion of the software defect records;
obtaining test case data comprising at least one of test case data or test case execution time data;
determining testing exposure time data using the test case data; and
computing the software reliability metric using the filtered software defect records and the testing exposure time data.
